(19) United States
(12) Patent Application Publication
(10) Pub. No.: US 2021/0166106 A1
(43) Pub. Date: Jun. 3, 2021

(54) RESIDUAL BINARY NEURAL NETWORK

(71) Applicant: The Regents of the University of California, Oakland, CA (US)

(72) Inventors: Mohammad Ghasemzadeh, San Diego, CA (US); Farinaz Koushanfar, San Diego, CA (US); Mohammad Samragh Razlighi, San Diego, CA (US)

(21) Appl. No.: 16/770,928

(22) PCT Filed: Dec. 12, 2018
(86) PCT No.: PCT/US18/65276

§ 371 Date: Jun. 8, 2020

Related U.S. Application Data
(60) Provisional application No. 62/597,689, filed on Dec. 12, 2017.

(51) Int. Cl. G06N 3/04; G06N 3/08; G06N 3/10

(52) U.S. Cl. CPC G06N 3/0481; G06N 3/10; G06N 3/08

(57) ABSTRACT

A method may include training, based a training dataset, a machine learning model. The machine learning model may include a neuron configured to generate an output by applying, to one or more inputs to the neuron, an activation function. The output of the activation function may be subject to a multi-level binarization function configured to generate an estimate of the output. The estimate of the output may include a first bit providing a first binary representation of the output and a second bit providing a second binary representation of a first residual error associated with the first binary representation of the output. In response to determining that the training of the machine learning model is complete, the trained machine learning model may be deployed to perform a cognitive task. Related systems and articles of manufacture, including computer program products, are also provided.

### RELATED APPLICATION

This application claims priority to U.S. Provisional Application No. 62/597,689 entitled “RESIDUAL BINARY NEURAL NETWORK” and filed on Dec. 12, 2017, the disclosure of which is incorporated herein by reference in its entirety.

### TECHNICAL FIELD

The subject matter described herein relates generally to machine learning and more specifically to the implementation and training of a residual binary neural network.

### BACKGROUND

Machine learning models may be trained to perform a variety of cognitive tasks including, for example, object identification, natural language processing, information retrieval, and speech recognition. A deep learning model such as, for example, a neural network, may be trained to perform a classification task by at least assigning input samples to one or more categories. The deep learning model may be trained to perform the classification task based on training data that has been labeled in accordance with the known category membership of each sample included in the training data. Alternatively and/or additionally, the deep learning model may be trained to perform a regression task. The regression task may require the deep learning model to predict, based at least on variations in one or more independent variables, corresponding changes in one or more dependent variables.

### SUMMARY

Systems, methods, and articles of manufacture, including computer program products, are provided for implementing and training a residual binary neural network. In some example embodiments, there is provided a system that includes at least one processor and at least one memory. The at least one memory may include program code that provides operations when executed by the at least one processor. The operations may include: training, based at least on a training dataset, a machine learning model, the machine learning model including a first neuron configured to generate an output by at least applying, to one or more inputs to the first neuron, an activation function, the output of the activation function being subject to a multi-level binarization function configured to generate an estimate of the output, and the estimate of the output including a first bit providing a first binary representation of the output and a second bit providing a second binary representation of a first residual error associated with the first binary representation of the output; and in response to determining that the training of the machine learning model is complete, deploying the trained machine learning model to perform a cognitive task.

In some variations, one or more features disclosed herein including the following features can optionally be included in any feasible combination. The first neuron is further configured to apply, to the one or more inputs, at least one binary weight having one of two values prior to applying the activation function.

In some variations, the training of the machine learning model may include: processing, with the machine learning model, the training dataset during a first training epoch using a function having a first slope to approximate the at least one binary weight; and processing, with the machine learning model, the training dataset during a second training epoch using the function having a second slope to approximate the at least one binary weight. The first training epoch and/or the second training epoch may include a forward pass and a backward pass of the training dataset through the machine learning model. The function may be a bounded, monotonically increasing function. The function may be a hyperbolic tangent function. The second slope may be greater than the first slope to increase a conformance between the function and a step function representative of the at least one binary weight. Using the function to approximate the at least one binary weight during the training of the machine learning model may generate the trained machine learning model to include one or more semi-binarized weights. The one or more semi-binarized weights may be replaced with one or more corresponding binary weights prior to the deployment of the trained machine learning model to perform the cognitive task.

In some variations, the training of the machine learning model may be determined to be complete based at least on a gradient of an error function associated with the machine learning model converging to a threshold value.

In some variations, the first residual error may include a first difference between the output and a first value corresponding to the first binary representation of the output.

In some variations, the second residual error may include a second difference between the first residual error and a second value corresponding to the second binary representation of the first residual error.

In some variations, the estimate of the output may further include a third bit providing a third binary representation of a second residual error associated with the second binary representation of the first residual error.

In some variations, the machine learning model may further include a second neuron configured to receive, as an input, the estimate of the output of the activation function applied at the first neuron. The second neuron may be further configured to apply, to the estimate of the output of the activation function, one or more binary weights. The one or more binary weights may be applied to the estimate of the output of the activation function by determining a dot product between the one or more binary weights and the estimate of the output of the activation function.

In some variations, the dot product may be determined by performing an exclusive NOR (XNOR) operation between the one or more binary weights and the estimate of the output of the activation function. The dot product may be further determined by performing a pop-count operation to determine a quantity of bits set by the exclusive NOR (XNOR) operation.

In some variations, a fixed quantity of hardware blocks may be used to perform the exclusive NOR (XNOR) operation and the pop-count operation.

In some variations, a quantity of hardware blocks used to perform the exclusive NOR (XNOR) operation and the pop-count operation may be determined based at least on a quantity of levels of binarization associated with the multi-level binarization function.

In some variations, a single hardware block may be configured to perform the exclusive NOR (XNOR) operation and the pop-count operation on the first bit comprising the estimate of the output of the activation function and the second bit comprising the estimate of the output of the activation function sequentially.

In some variations, multiple hardware blocks may be configured to perform the exclusive NOR (XNOR) operation and the pop-count operation on the first bit comprising the estimate of the output of the activation function and the second bit comprising the estimate of the output of the activation function at least partially in parallel.

In some variations, the machine learning model may be a neural network.

In some variations, the machine learning model may be a binary neural network.

In some variations, the activation function may include a linear function or a non-linear function.

In some variations, the activation function may include a sigmoid function and/or a rectified linear unit (ReLU) function.

In some variations, the cognitive task may be performed by at least applying the trained machine learning model. An output of the trained machine learning model may be provided as a result of the cognitive task.

In some variations, the cognitive task may include a classification task and/or a regression task.

In another aspect, there is provided a method for implementing and training a residual binary network. The method may include: training, based at least on a training dataset, a machine learning model, the machine learning model including a first neuron configured to generate an output by at least applying, to one or more inputs to the first neuron, an activation function, the output of the activation function being subject to a multi-level binarization function configured to generate an estimate of the output, and the estimate of the output including a first bit providing a first binary representation of the output and a second bit providing a second binary representation of a first residual error associated with the first binary representation of the output; and in response to determining that the training of the machine learning model is complete, deploying the trained machine learning model to perform a cognitive task.

In some variations, one or more features disclosed herein including the following features can optionally be included in any feasible combination. The first neuron is further configured to apply, to the one or more inputs, at least one binary weight having one of two values prior to applying the activation function.

In some variations, the training of the machine learning model may include: processing, with the machine learning model, the training dataset during a first training epoch using a function having a first slope to approximate the at least one binary weight; and processing, with the machine learning model, the training dataset during a second training epoch using the function having a second slope to approximate the at least one binary weight. The first training epoch and/or the second training epoch may include a forward pass and a backward pass of the training dataset through the machine learning model. The function may be a bounded, monotonically increasing function. The function may be a hyperbolic tangent function. The second slope may be greater than the first slope to increase a conformance between the function and a step function representative of the at least one binary weight. Using the function to approximate the at least one binary weight during the training of the machine learning model may generate the trained machine learning model to include one or more semi-binarized weights. The one or more semi-binarized weights may be replaced with one or more corresponding binary weights prior to the deployment of the trained machine learning model to perform the cognitive task.

In some variations, the training of the machine learning model may be determined to be complete based at least on a gradient of an error function associated with the machine learning model converging to a threshold value.

In some variations, the first residual error may include a first difference between the output and a first value corresponding to the first binary representation of the output.

In some variations, the second residual error may include a second difference between the first residual error and a second value corresponding to the second binary representation of the first residual error.

In some variations, the estimate of the output may further include a third bit providing a third binary representation of a second residual error associated with the second binary representation of the first residual error.

In some variations, the machine learning model may further include a second neuron configured to receive, as an input, the estimate of the output of the activation function applied at the first neuron. The second neuron may be further configured to apply, to the estimate of the output of the activation function, one or more binary weights. The one or more binary weights may be applied to the estimate of the output of the activation function by determining a dot product between the one or more binary weights and the estimate of the output of the activation function.

In some variations, the dot product may be determined by performing an exclusive NOR (XNOR) operation between the one or more binary weights and the estimate of the output of the activation function. The dot product may be further determined by performing a pop-count operation to determine a quantity of bits set by the exclusive NOR (XNOR) operation.

In some variations, a fixed quantity of hardware blocks may be used to perform the exclusive NOR (XNOR) operation and the pop-count operation.

In some variations, a quantity of hardware blocks used to perform the exclusive NOR (XNOR) operation and the pop-count operation may be determined based at least on a quantity of levels of binarization associated with the multi-level binarization function.

In some variations, a single hardware block may be configured to perform the exclusive NOR (XNOR) operation and the pop-count operation on the first bit comprising the estimate of the output of the activation function and the second bit comprising the estimate of the output of the activation function sequentially.

In some variations, multiple hardware blocks may be configured to perform the exclusive NOR (XNOR) operation and the pop-count operation on the first bit comprising the estimate of the output of the activation function and the second bit comprising the estimate of the output of the activation function at least partially in parallel.

In some variations, the machine learning model may be a neural network.

In some variations, the machine learning model may be a binary neural network.

In some variations, the activation function may include a linear function or a non-linear function.

In some variations, the activation function may include a sigmoid function and/or a rectified linear unit (ReLU) function.

In some variations, the method may further include: performing the cognitive task by at least applying the trained machine learning model; and providing, as a result of the cognitive task, an output of the trained machine learning model.

In another aspect, there is provided a computer program product that includes a non-transitory computer readable medium storing instructions. The instructions may cause operations when executed by at least one data processor. The operations may include: training, based at least on a training dataset, a machine learning model, the machine learning model including a first neuron configured to generate an output by at least applying, to one or more inputs to the first neuron, an activation function, the output of the activation function being subject to a multi-level binarization function configured to generate an estimate of the output, and the estimate of the output including a first bit providing a first binary representation of the output and a second bit providing a second binary representation of a first residual error associated with the first binary representation of the output; and in response to determining that the training of the machine learning model is complete, deploying the trained machine learning model to perform a cognitive task.

In another aspect, there is provided an apparatus for implementing and training a residual neural network. The apparatus may include: means for training, based at least on a training dataset, a machine learning model, the machine learning model including a first neuron configured to generate an output by at least applying, to one or more inputs to the first neuron, an activation function, the output of the activation function being subject to a multi-level binarization function configured to generate an estimate of the output, and the estimate of the output including a first bit providing a first binary representation of the output and a second bit providing a second binary representation of a first residual error associated with the first binary representation of the output; and means for responding to a determination that the training of the machine learning model is complete by at least deploying the trained machine learning model to perform a cognitive task.

In another aspect, there is provided a system for performing a cognitive task. The system may include at least one processor and at least one memory. The at least one memory may include program code that provides operations when executed by the at least one processor. The operations may include: performing a cognitive task by at least applying a machine learning model trained to perform the cognitive task, the machine learning model including a first neuron configured to generate an output by at least applying, to one or more inputs to the first neuron, an activation function, the output of the activation function being subject to a multi-level binarization function configured to generate an estimate of the output, and the estimate of the output including a first bit providing a first binary representation of the output and a second bit providing a second binary representation of a first residual error associated with the first binary representation of the output; and providing, as a result of the cognitive task, an output of the machine learning model.

In some variations, one or more features disclosed herein including the following features can optionally be included in any feasible combination. The first neuron is further configured to apply, to the one or more inputs, at least one binary weight having one of two values prior to applying the activation function.

In some variations, the machine learning model may be trained by at least processing, with the machine learning model, the training dataset during a first training epoch using a function having a first slope to approximate the at least one binary weight, and processing, with the machine learning model, the training dataset during a second training epoch using the function having a second slope to approximate the at least one binary weight. The first training epoch and/or the second training epoch may include a forward pass and a backward pass of the training dataset through the machine learning model. The function may be a bounded, monotonically increasing function. The function may be a hyperbolic tangent function. The second slope may be greater than the first slope to increase a conformance between the function and a step function representative of the at least one binary weight. Using the function to approximate the at least one binary weight during the training of the machine learning model may generate the trained machine learning model to include one or more semi-binarized weights. The one or more semi-binarized weights may be replaced with one or more corresponding binary weights prior to the deployment of the trained machine learning model to perform the cognitive task.

In some variations, the training of the machine learning model may be determined to be complete based at least on a gradient of an error function associated with the machine learning model converging to a threshold value.

In some variations, the first residual error may include a first difference between the output and a first value corresponding to the first binary representation of the output.

In some variations, the second residual error may include a second difference between the first residual error and a second value corresponding to the second binary representation of the first residual error.

In some variations, the estimate of the output may further include a third bit providing a third binary representation of a second residual error associated with the second binary representation of the first residual error.

In some variations, the machine learning model may further include a second neuron configured to receive, as an input, the estimate of the output of the activation function applied at the first neuron. The second neuron may be further configured to apply, to the estimate of the output of the activation function, one or more binary weights. The one or more binary weights may be applied to the estimate of the output of the activation function by determining a dot product between the one or more binary weights and the estimate of the output of the activation function.

In some variations, the dot product may be determined by performing an exclusive NOR (XNOR) operation between the one or more binary weights and the estimate of the output of the activation function. The dot product may be further determined by performing a pop-count operation to determine a quantity of bits set by the exclusive NOR (XNOR) operation.

In some variations, a fixed quantity of hardware blocks may be used to perform the exclusive NOR (XNOR) operation and the pop-count operation.

In some variations, a quantity of hardware blocks used to perform the exclusive NOR (XNOR) operation and the pop-count operation may be determined based at least on a quantity of levels of binarization associated with the multi-level binarization function.

In some variations, a single hardware block may be configured to perform the exclusive NOR (XNOR) operation and the pop-count operation on the first bit comprising the estimate of the output of the activation function and the second bit comprising the estimate of the output of the activation function sequentially.

In some variations, multiple hardware blocks may be configured to perform the exclusive NOR (XNOR) operation and the pop-count operation on the first bit comprising the estimate of the output of the activation function and the second bit comprising the estimate of the output of the activation function at least partially in parallel.

In some variations, the machine learning model may be a neural network.

In some variations, the machine learning model may be a binary neural network.

In some variations, the activation function may include a linear function or a non-linear function.

In some variations, the activation function may include a sigmoid function and/or a rectified linear unit (ReLU) function.

In some variations, the cognitive task may include a classification task and/or a regression task.

In another aspect, there is provided a method for performing a cognitive task. The method may include: performing a cognitive task by at least applying a machine learning model trained to perform the cognitive task, the machine learning model including a first neuron configured to generate an output by at least applying, to one or more inputs to the first neuron, an activation function, the output of the activation function being subject to a multi-level binarization function configured to generate an estimate of the output, and the estimate of the output including a first bit providing a first binary representation of the output and a second bit providing a second binary representation of a first residual error associated with the first binary representation of the output; and providing, as a result of the cognitive task, an output of the machine learning model.

In some variations, one or more features disclosed herein including the following features can optionally be included in any feasible combination. The first neuron is further configured to apply, to the one or more inputs, at least one binary weight having one of two values prior to applying the activation function.

In some variations, the method may further include training the machine learning model by at least processing, with the machine learning model, the training dataset during a first training epoch using a function having a first slope to approximate the at least one binary weight, and processing, with the machine learning model, the training dataset during a second training epoch using the function having a second slope to approximate the at least one binary weight. The first training epoch and/or the second training epoch may include a forward pass and a backward pass of the training dataset through the machine learning model. The function may be a bounded, monotonically increasing function. The function may be a hyperbolic tangent function. The second slope may be greater than the first slope to increase a conformance between the function and a step function representative of the at least one binary weight. Using the function to approximate the at least one binary weight during the training of the machine learning model may generate the trained machine learning model to include one or more semi-binarized weights. The one or more semi-binarized weights may be replaced with one or more corresponding binary weights prior to the deployment of the trained machine learning model to perform the cognitive task.

In some variations, the training of the machine learning model may be determined to be complete based at least on a gradient of an error function associated with the machine learning model converging to a threshold value.

In some variations, the first residual error may include a first difference between the output and a first value corresponding to the first binary representation of the output.

In some variations, the second residual error may include a second difference between the first residual error and a second value corresponding to the second binary representation of the first residual error.

In some variations, the estimate of the output may further include a third bit providing a third binary representation of a second residual error associated with the second binary representation of the first residual error.

In some variations, the machine learning model may further include a second neuron configured to receive, as an input, the estimate of the output of the activation function applied at the first neuron. The second neuron may be further configured to apply, to the estimate of the output of the activation function, one or more binary weights. The one or more binary weights may be applied to the estimate of the output of the activation function by determining a dot product between the one or more binary weights and the estimate of the output of the activation function.

In some variations, the dot product may be determined by performing an exclusive NOR (XNOR) operation between the one or more binary weights and the estimate of the output of the activation function. The dot product may be further determined by performing a pop-count operation to determine a quantity of bits set by the exclusive NOR (XNOR) operation.

In some variations, a fixed quantity of hardware blocks may be used to perform the exclusive NOR (XNOR) operation and the pop-count operation.

In some variations, a quantity of hardware blocks used to perform the exclusive NOR (XNOR) operation and the pop-count operation may be determined based at least on a quantity of levels of binarization associated with the multi-level binarization function.

In some variations, a single hardware block may be configured to perform the exclusive NOR (XNOR) operation and the pop-count operation on the first bit comprising the estimate of the output of the activation function and the second bit comprising the estimate of the output of the activation function sequentially.

In some variations, multiple hardware blocks may be configured to perform the exclusive NOR (XNOR) operation and the pop-count operation on the first bit comprising the estimate of the output of the activation function and the second bit comprising the estimate of the output of the activation function at least partially in parallel.

In some variations, the machine learning model may be a neural network.

In some variations, the machine learning model may be a binary neural network.

In some variations, the activation function may include a linear function or a non-linear function.

In some variations, the activation function may include a sigmoid function and/or a rectified linear unit (ReLU) function.

In some variations, the cognitive task may include a classification task and/or a regression task.

In another aspect, there is provided a computer program product that includes a non-transitory computer readable medium storing instructions. The instructions may cause operations when executed by at least one data processor. The operations may include: performing a cognitive task by at least applying a machine learning model trained to perform the cognitive task, the machine learning model including a first neuron configured to generate an output by at least applying, to one or more inputs to the first neuron, an activation function, the output of the activation function being subject to a multi-level binarization function configured to generate an estimate of the output, and the estimate of the output including a first bit providing a first binary representation of the output and a second bit providing a second binary representation of a first residual error associated with the first binary representation of the output; and providing, as a result of the cognitive task, an output of the machine learning model.

In another aspect, there is provided an apparatus for implementing and training a residual neural network. The apparatus may include: means for performing a cognitive task by at least applying a machine learning model trained to perform the cognitive task, the machine learning model including a first neuron configured to generate an output by at least applying, to one or more inputs to the first neuron, an activation function, the output of the activation function being subject to a multi-level binarization function configured to generate an estimate of the output, and the estimate of the output including a first bit providing a first binary representation of the output and a second bit providing a second binary representation of a first residual error associated with the first binary representation of the output; and means for providing, as a result of the cognitive task, an output of the machine learning model.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts a schematic diagram illustrating a neural network, in accordance with some example embodiments;

FIG. 1B depicts a schematic diagram illustrating a neural network, in accordance with some example embodiments;

FIG. 1C depicts an example of a neuron, in accordance with some example embodiments;

FIG. 2A depicts an example of a multi-level binarization scheme, in accordance with some example embodiments;

FIG. 2B depicts a graph illustrating a hard binarization scheme and a graph illustrating a multi-level binarization scheme, in accordance with some example embodiments;

FIG. 3 depicts an example of a bounded, monotonically increasing function for representing a binary weight, in accordance with some example embodiments;

FIG. 4 depicts a flowchart illustrating a process for training a residual binary neural network, in accordance with some example embodiments;

FIG. 5A depicts a graph illustrating a resource utilization associated with a residual binary neural network, in accordance with some example embodiments;

FIG. 5B depicts a graph illustrating a tradeoff in the latency and accuracy of a residual binary neural network, in accordance with some example embodiments;

FIG. 6 depicts a schematic diagram illustrating an example of a hardware architecture for implementing a residual binary neural network, in accordance with some example embodiments;

FIG. 7 depicts a block diagram illustrating a computing system, in accordance with some example embodiments.

When practical, similar reference numbers denote similar structures, features, or elements.

### DETAILED DESCRIPTION

A neural network may include a plurality of interconnected neurons organized into one or more layers including, for example, core computation layers, normalization layers, pooling layers, non-linearity layers, and/or the like. Each neuron in the neural network may be configured to generate an output by applying, to one or more inputs, at least one weight before passing the weighted inputs through an activation function. In a conventional full-precision neural network, at least some of the weights applied to the inputs received at the neurons in the neural network may be floating-point values. Moreover, the activation functions applied by the neurons in the full precision neural network may also be configured to output floating-point values. By contrast, the neurons in a binary neural network may apply binary weights and binary activation functions. That is, the weights in the binary neural network and the outputs from the activation functions in the binary neural network may take on one of two possible values. Accordingly, a binary neural network may consume fewer resources and be associated with less computational complexity than a conventional full-precision neural network. However, a binary neural network may also be less accurate and slower to train than a full-precision neural network.

In some example embodiments, the neurons of a residual binary neural network may be configured to apply binary weights. For example, each neuron in the residual binary neural network may apply, to one or more inputs, at least one weight having one of two possible values. Moreover, the neurons of the residual binary neural network may be configured to generate an output by at least applying, to the weighted inputs, a residual activation function. The residual activation function may be configured to apply a multi-level binarization scheme when generating an output. Accordingly, instead of a binary output in which a single bit is used to represent one of the two possible values, the output of the residual activation function may a sequence of bits in which the residual error associated with the value represented by one bit in the sequence of bits may be represented by one or more subsequent bits in the sequence of bits.

In some example embodiments, the residual binary neural network may be trained in order to minimize an error in an output of the residual binary neural network. For example, the error in the output of the residual binary neural network may include a discrepancy between the output of the residual binary neural network and the correct output for a cognitive task cognitive task such as, for example, object identification, natural language processing, information retrieval, and speech recognition. Training the residual binary neural network may include determining a gradient of an error function (e.g., mean squared error (MSE), cross entropy, and/or the like) associated with the residual binary neural network. The gradient of the error function associated with the residual binary neural network may be determined, for example, by backward propagating the error in the output of the residual binary neural network. Meanwhile, the error in the output of the residual binary neural network may be minimized by at least updating one or more weights applied by the neurons in the residual binary neural network until the gradient of the error function converges, for example, to a local minimum and/or another threshold value.

The binary weights applied by the neurons in the residual binary neural network may correspond to a step function, which may transition abruptly between two values. However, the presence of a step function in the residual binary neural network may thwart the training of the residual binary neural network by at least preventing the determination of a gradient for a corresponding error function. As such, in some example embodiments, during the training of the residual binary neural network, the binary weights included in the residual binary neural network may be represented using a bounded, monotonically increasing function such as, for example, a hyperbolic tangent function and/or the like. Increasing the slope of the bounded, monotonically increasing function may increase its conformance to a step function corresponding to the binary weights applied in the residual binary neural network. However, maximizing the slope of the bounded, monotonically increasing function may also eliminate most of the gradient required to train the residual binary neural network. As such, the slope of the bounded, monotonically increasing function may be gradually increased during the training of the residual binary neural network in order determine, for each neuron in the residual binary neural network, one or more semi-binarized weights. These semi-binarized weights may be replaced with binary weights once the training of the residual binary neural network is complete.

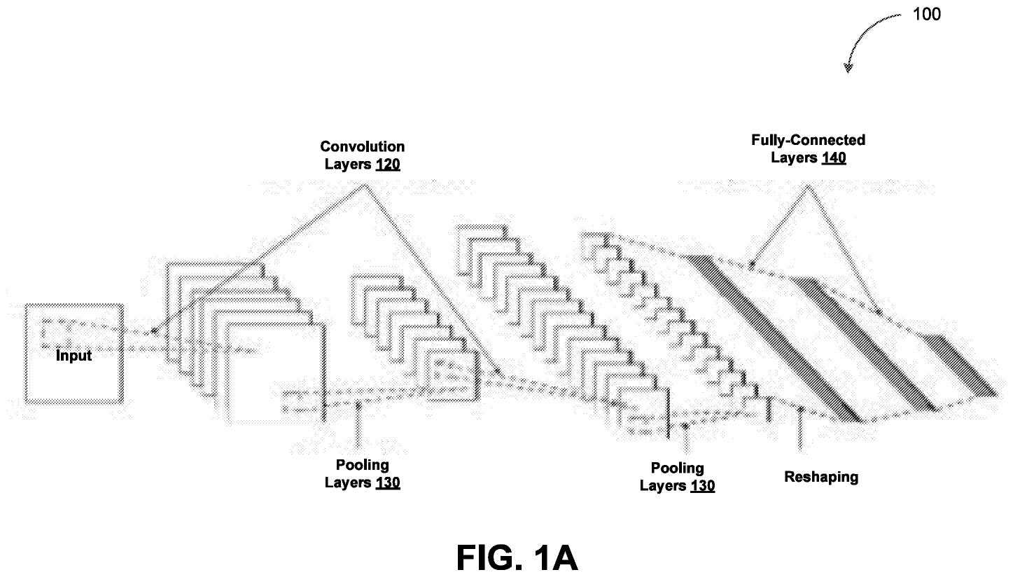

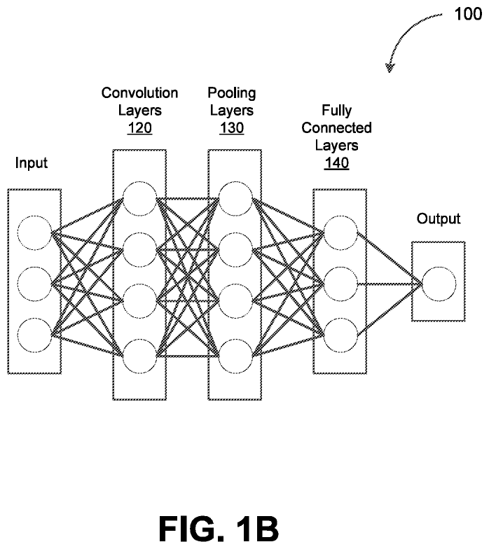

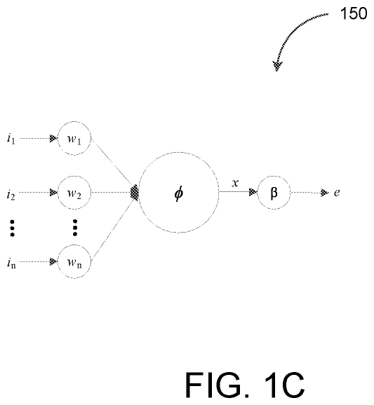

FIGS. 1A-B depict schematic diagrams illustrating a residual binary neural network 100, in accordance with some example embodiments. In some example embodiments, the neural network 110 may be a type of deep learning model that may be trained to perform a cognitive task such as, for example, object identification, natural language processing, information retrieval, speech recognition, and/or the like. Examples of layers that may be present in a deep learning model such as the residual binary neural network 100 are shown in Table 1 below. As shown in FIG. 1A, the residual binary neural network 100 may include a plurality of layers including, for example, one or more convolution layers 120, pooling layers 130, and fully-connected layers 140.

TABLE 1

| DL Layers | | Description |
|---|---|---|
| Core Computations | Fully- Connected | ${x}_{i}^{( I )} = {\sum }_{j = 1}^{N \text{?}} {g}_{ij}^{( I - 1 )} \times {z}_{j}^{( I - 1 )}$ |
| | 2D Convolution | ${x}_{ij}^{( I )} = {\sum }_{\text{?} = 1}^{k} {\sum }_{\text{?} = 1}^{k} {θ}_{\text{?}}^{( I - 1 )} \times {z}_{( I + {s}_{i} ) ( j + {s}_{2} )}^{I - 1}$ |
| Normalization | L₂ Normalization | ${x}_{i}^{( I )} = \frac{{x}_{i}^{( I )}}{\sqrt{{\sum }_{j = 1}^{{N}_{t}} {\vert {x}_{j}^{( I )} \vert}^{2}}}$ |
| | Batch Normalization | ${x}_{i}^{( I )} = \frac{{x}_{i}^{\text{?}} - {p}_{ij}^{\text{?}}}{\sqrt{\frac{1}{\text{?}} {\sum }_{\text{?}}^{\text{?}} ( {s}_{j}^{( I )} - p \text{?} ) \text{?}}}$ |
| Pooling | 2D Max Pooling | ${x}_{ij}^{( I )} = {Max ( {y}_{( i + {s}_{1} ) ( j + {s}_{2} )}^{I - 1} )}_{{{s}_{1} ∈ \{ 1 , 2 , … , k )}_{{s}_{2} ∈ \{ 1 , 2 , … , k )}}$ |
| | 2D Mean Pooling | ${x}_{ij}^{( I )} = {Mean ( {z}_{( i + {s}_{1} ) ( j + {s}_{2} )}^{I - 1} )}_{{{s}_{1} ∈ \{ 1 , 2 , … , k )}_{{s}_{2} ∈ \{ 1 , 2 , … , k )}}$ |
| Non- linearities | Softmax | ${z}_{i}^{( I )} = \frac{\text{?}}{{\sum }_{j = 1}^{{N}_{𝓁}} {e}^{{x}_{f}^{( I )}}}$ |
| | Sigmoid | ${z}_{i}^{( I )} = \frac{{e}^{{x}_{f}^{( I )}}}{\text{?} + e \text{?}}$ |
| | Tangent Hyperbolic | ${z}_{i}^{( I )} = \frac{Sinh ( {x}_{i}^{( I )} )}{Cosh ( {x}_{i}^{( I )} )}$ |
| | Rectified | zᵢ^{(l)} = Max(0, xᵢ^{(l)}) |
| | Linear unit | |

$\text{?} \text{indicates text missing or illegible when filed}$

As shown in FIG. 1B, the residual binary neural network 100 may include a plurality of interconnected neurons organized, for example, into the one or more convolution layers 120, pooling layers 130, and fully-connected layers 140. FIG. 1C depicts an example of a neuron 150, in accordance with some example embodiments. It should be appreciated that the neuron 150 may implement one or more of the plurality of interconnected neurons shown in FIG. 1B.

Referring again to FIG. 1C, the neuron 150 may be configured to apply, to one or more inputs (e.g., i₁, i₂, . . . iₙ), one or more corresponding weights from a weight vector \vec{w} (e.g., w₁, w₂, . . . wₙ). The neuron 150 may be further configured to apply an activation function Ø to the one or more weighted inputs (e.g., w₁i₁, w₂i₂, . . . wₙiₙ). For example, the activation function Ø may be a linear function or a non-linear function (e.g., a sigmoid function, a rectified linear unit (ReLU) function, and/or the like). Moreover, FIG. 1C shows that an output x of applying the activation function Ø to the one or more weighted inputs (e.g., w₁i₁, w₂i₂, . . . wₙiₙ) may be binarized, for example, by applying a binarization function β. The binarization function β may be applied to generate a result e, which may be an estimate of the output x of the activation function Ø.

In a conventional binary neural network, the binarization function β may apply a hard binarization scheme to generate, based on the output x of the activation function Ø, the result e. As such, in a conventional binary neural network, the result e of the binarization function β may have one of two possible values (e.g., γ or −γ), which may be represented using a single bit. By contrast, in the residual binary neural network 100, the binarization function β may apply a multi-level binarization scheme. The multi-level binarization scheme may generate the result e to include a sequence of bits in which the residual error associated with the value represented by one bit in the sequence of bits may be represented by one or more subsequent bits in the sequence of bits. For example, when the binarization function β applies, to the output x of the activation function Ø, a multi-level binarization scheme, the result e may include a first bit providing a binary representation of the output x and a second bit providing a binary representation of a residual error associated with the binary representation of the output x.

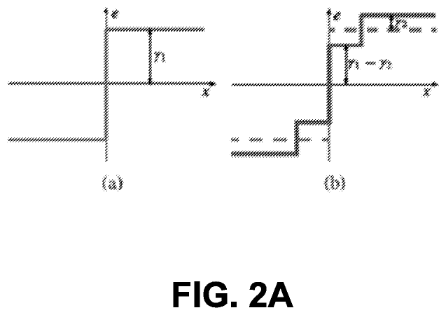

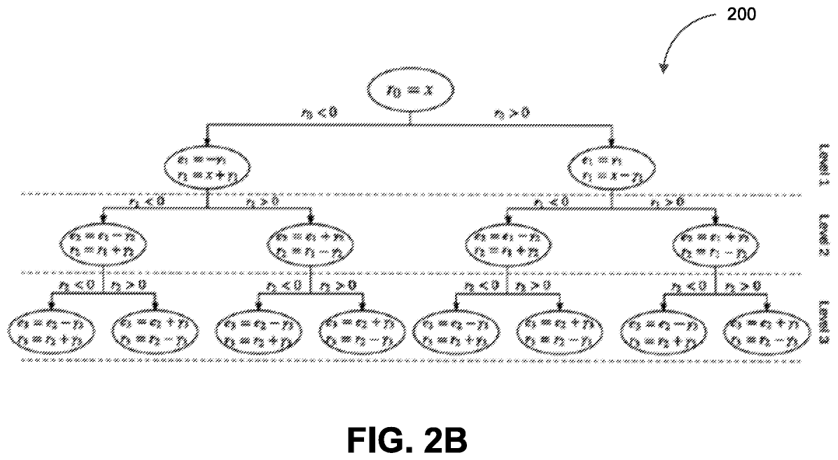

To further illustrate, FIG. 2A depicts a graph (a) illustrating a hard binarization scheme and a graph (b) illustrating a multi-level binarization scheme, in accordance with some example embodiments. As graph (a) shows, when a hard binarization scheme is applied to the output x of the binarization function β, the result e may estimate the output x a single value selected from two possible values. For instance, FIG. 2A shows that the result e may estimate the output x as a first value γ₁. By contrast, graph (b) shows that when a multi-level binarization scheme is applied to the output x of the binarization function β, the result e may estimate the output x as a sequence of values, each of which being selected from two possible values. For example, as shown in FIG. 2A, the result e may estimate the output x using the first value γ₁ and a second value γ₂.

FIG. 2B depicts an example of a multi-level binarization scheme 200, in accordance with some example embodiments. Referring to FIGS. 1C and 2A, the multi-level binarization scheme 200 may be applied to the output x of the activation function Ø in order to generate the result e, which may be an estimate of the output x of the activation function Ø. The multi-level binarization scheme 200 may include an l quantity of levels of binarization, each of which generating a one-bit estimate eᵢ such that the result e may be a sequence having an l quantity of bits (e.g., b₁, b₂, . . . , bₗ). In the example shown in FIG. 2B, the multi-level binarization scheme 200 may include three successive levels of binarization. However, it should be appreciated that the multi-level binarization scheme 200 may include a different quantity of levels of binarization. Moreover, increasing the levels of binarization in the multi-level binarization scheme 200 may increase an accuracy of the result e in estimating the output x of the activation function Ø.

Referring again to FIG. 2B, the first level of the multi-level binarization scheme 200 may generate a first estimate e₁ of the output x. As shown in FIG. 2B, the first estimate e₁ may be one of two values (e.g., γ₁ or −γ₁). A first residual error r₁ of the first estimate e₁ associated with the first estimate e₁ may correspond to a difference between the output x and the value of the first estimate e₁. Meanwhile, the second level of the multi-level binarization scheme 200 may generate a second estimate e₂ for the first residual error r₁ of the first estimate e₁ from the preceding first level of binarization. The second estimate e₂ may be one of two values generating by adding, to the first estimate e₁, one of two values (e.g., γ₂ or −γ₂). A second residual error r₂ of the second estimate e₂ associated with the second estimate e₂ may correspond to a difference between the first residual error r₁ and the one of the two values (e.g., γ₂ or −γ₂) added to the first estimate e₁ to generate the second estimate e₂.

Alternatively and/or additionally, the third level of the multi-level binarization scheme 200 may generate a third estimate e₃ for the second residual error r₂ of the second estimate e₂ from the preceding second level of binarization. The third estimate e₃ may be one of two values generating by adding, to the second estimate e₁, one of two values (e.g., γ₃ or −γ₃). Furthermore, a third residual error r₃ of the third estimate e₃ associated with the third estimate e₃ may correspond to a difference between the second residual error r₂ and the one of the two values (e.g., γ₃ or −γ₃) added to the second estimate e₂ to generate the second estimate e₃.

The value γᵢ for each i-th layer of the multi-level binarization scheme 200 may be learned during the training of the residual binary neural network 100. For example, the value γᵢ for each i-th layer of the multi-level binarization scheme 200 may be fine-tuned using a gradient approximation technique. Moreover, the same value γᵢ may be associated with the neurons occupying the same layer of the residual binary neural network 100 while different values of γᵢ may be associated with neurons occupying different layers of the residual binary neural network 100. The values of γᵢ may diverge across the different layers of the residual binary neural network 100 as a result of training the residual binary neural network.

In some example embodiments, the result e from the binarization function β applying the multi-level binarization scheme 200 to the output x of the activation function Ø may be a feature vector \vec{e} that includes the sequence having the l quantity of bits (e.g., b₁, b₂, . . . , bₗ). For instance, in the example shown in FIG. 2B, the feature vector \vec{e} that is generated by applying the binarization function β to the output x of the activation function Ø may include three bits (e.g., b₁, b₂, and b₃), each of which representing one of the first estimate e₁, the second estimate e₂, and the third estimate e₃. Moreover, the feature vector \vec{e} that is generated by applying the binarization function β to the output x of the activation function Ø may be passed onto another neuron, for example, in a subsequent layer of the residual binary neural network 100.

To apply the weight vector \vec{w} to the feature vector \vec{e} may require determining a dot product between the weight vector \vec{w} and the feature vector \vec{e}. In some example embodiments, because the values the weight vector \vec{w} and the feature vector \vec{e} are binary, the dot product between the weight vector \vec{w} to and the feature vector \vec{e} may be determined by performing an exclusive NOR (XNOR) operation between corresponding values in the weight vector \vec{w} and the feature vector \vec{e} followed by a pop-count operation to determine a quantity of bits set by the exclusive NOR operation. By contrast, the weight vector \vec{w} to and the feature vector \vec{e} in a conventional full-precision neural network may include floating-point values. As such, a conventional full-precision neural network may be required to multiplication operations in order to apply the weight vector \vec{w} to and the feature vector \vec{e}. It should be appreciated that an exclusive NOR operation may be less computationally complex than a multiplication operation. Accordingly, the residual binary neural network 100 may require less time and/or energy to determine the dot product between the weight vector \vec{w} to and the feature vector \vec{e}.

Equation (1) below depicts the computation of the dot product between the weight vector \vec{w}=γ_{w}\vec{s}_{w} to and the feature vector \vec{e}=Σᵢ₌₁^{l} γₑᵢ\vec{s}ₑᵢ in the residual binary neural network 100.

dot(\vec{w},\vec{e})=dot(Σᵢ₌₁^{l}γₑᵢ\vec{s}ₑᵢ,γ_{w}\vec{s}_{w})=Σᵢ₌₁^{l}γₑᵢγ_{w} dot(\vec{s}ₑᵢ,\vec{s}_{w})=Σᵢ₌₁^{l}γₑᵢγ_{w}xnorpopcount(\vec{b}_{di},\vec{b}_{w}) (1)

wherein {γₑᵢ, γ_{w}} may denote scalar values, {\vec{s}ₑᵢ, \vec{s}_{w}} may denote the sign vectors corresponding to the weight vector \vec{w} to and the feature vector \vec{e}, and {\vec{b}ₑᵢ, \vec{b}_{w}} may correspond to the binary representations of the sign vectors {\vec{s}ₑᵢ, \vec{s}_{w}}.

In some example embodiments, the feature vector \vec{e} may be encoded into a stream of binary values (e.g., {bₑᵢ|i∈1, 2, . . . , l)}) in order to determine the dot product between the weight vector \vec{w} to and the feature vector \vec{e} by performing an exclusive NOR (XNOR) operation followed by a pop-count operation. Table 2 below depicts pseudo code for encoding the feature vector \vec{e}.

TABLE 2
Algorithm 1 l-level residual encoding algorithm

| inputs: γ₁, γ₂, ..., γₗ, x | |
|---|---|
| outputs: bₑ₁, bₑ₂, bₑₗ | |
| 1: | r ← x |
| 2: | e ← 0 |
| 3: | for i = 1 ... l do |
| 4: | bₑᵢ ← Binarize(Sign(r)) |
| 5: | e ← e + Sign(r) × γᵢ |
| 6: | r ← r − Sign(r) × γᵢ |
| 7: | end for |

In some example embodiments, the residual binary neural network 100 may be trained by determining a gradient of an error function (e.g., mean squared error (MSE), cross entropy, and/or the like) associated with the residual binary neural network 100. The gradient of the error function associated with the residual binary neural network 100 may be determined, for example, by backward propagating the error in the output of the residual binary neural network. Meanwhile, the error in the output of the residual binary neural network 100 may be minimized by at least updating one or more weights applied by the neurons in the residual binary neural network 100 until the gradient of the error function converges, for example, to a local minimum and/or another threshold value. For example, referring to FIG. 1C, the error in the output of the residual binary neural network 100 may be minimized by at least updating the weights in the weight vector \vec{w} (e.g., w₁, w₂, . . . wₙ) until the gradient of the error function converges.

As noted, the neurons in the residual binary neural network 100 may apply binary weights. For example, each of the weights in the weight vector \vec{w} (e.g., w₁, w₂, . . . wₙ) applied by at the neuron 150 may have one of two possible values. These binary weights may correspond to a step function exhibiting an abrupt transition between two values. However, the presence of a step function in the residual binary neural network 100 may thwart the training of the residual binary neural network 100 by at least preventing the determination of a gradient for a corresponding error function.

As such, in some example embodiments, during the training of the residual binary neural network 100, the binary weights included in the residual binary neural network 100 may be represented using a bounded, monotonically increasing function such as, for example, a hyperbolic tangent function and/or the like. The slope of the bounded, monotonically increasing function may determine its conformance to a step function representative of the binary weights included in the residual binary neural network 100.

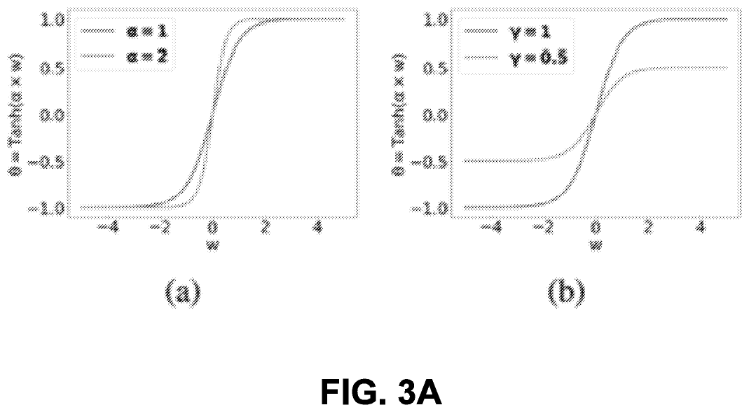

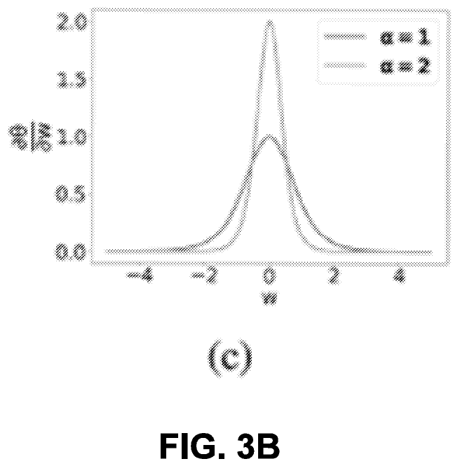

To further illustrate, FIG. 3A depicts an example of a bounded, monotonically increasing function, in accordance with some example embodiments. In some example embodiments, the bounded, monotonically increasing function H(αW) may be a hyperbolic tangent function. The output θ of the monotonically, increasing function H(αW) may approximate the binary weights W that are applied by the residual binary neural network 100. The output θ of the monotonically increasing function H(αW) may be computed in accordance with Equation (2) below.

θ=γH(αW) (2)

wherein α may denote a slope of the bounded, monotonically increasing function H(αW), and γ may denote a trainable scalar adjusting the maximum value and the minimum value of the output θ. The conformance of the bounded, monotonically increasing function H(αW) to a step function representative of binary weights may be determined based at least on the slope α and the scalar γ.

FIG. 3A depicts a graph (a) illustrating that increasing the slope α of the bounded, monotonically increasing function H(αW) may increase its conformance to the step function corresponding to the binary weights W applied in the residual binary neural network 100. For example, graph (a) shows that when the slope α of the bounded, monotonically increasing function H(αW) is lower, the output θ of the monotonically, increasing function H(αW) may exhibit a more gradual transition between two values. By contrast, when the slope α of the bounded, monotonically increasing function H(αW) is higher, the output θ of the monotonically, increasing function H(αW) may exhibit a steeper transition between two values, which may correspond more to abrupt transition that is observed in the output of a step function.

FIG. 3B also depicts a graph (b) illustrating that changing the scalar γ applied to the bounded, monotonically increasing function H(αW) may change the magnitude of the output θ of the monotonically, increasing function H(αW). For example, graph (b) shows that increasing the scalar γ may increase the maximum value and decrease the minimum value of the output θ. Alternatively, decreasing the scalar γ may decrease the maximum value and increase the minimum value of the output θ. The value of the scalar γ may be adjusted such that the output θ of the monotonically, increasing function H(αW) approximates the values of the binary weights W applied in the residual binary neural network 100.

In some example embodiments, the slope α of the bounded, monotonically increasing function H(αW) may be increased gradually during the training of the residual binary neural network 100. Otherwise, maximizing the slope α of the bounded, monotonically increasing function H(αW) at the start of training may eliminate most of the gradient required to train the residual binary neural network 100. To prevent the elimination of the gradient required to train the residual binary neural network 100, the slope α of the bounded, monotonically increasing function H(αW) may be gradually increased during the training of the residual binary neural network 100.

For example, the slope α of the bounded, monotonically increasing function H(αW) may be increased over successive training epochs. As used herein, a training epoch may refer to one forward pass and one backward pass of a training dataset through the residual binary neural network 100. By increasing the slope α gradually through the course of training, the trained residual binary neural network 100 may include one or more semi-binarized weights. These semi-binarized weights may be replaced with binary weights once the training of the residual binary neural network 100 is complete. For example, the training of the residual binary neural network 100 may be determined to be complete when the gradient of the error function associated with the residual binary neural network 100 converges, for instance, to a local minimum and/or another threshold value.

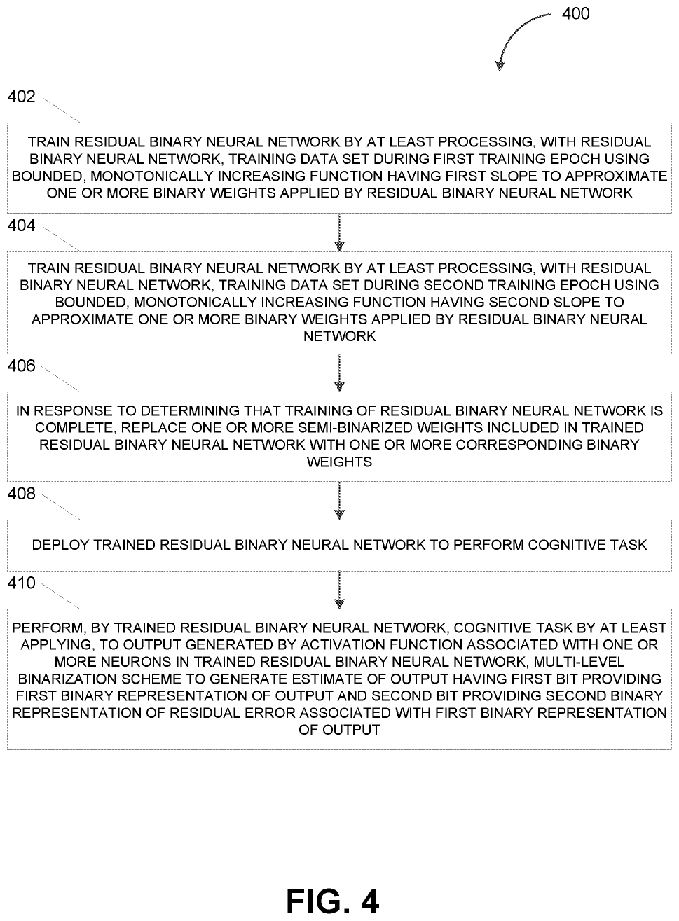

FIG. 4A depicts a flowchart illustrating a process 400 for training a residual binary neural network to perform a cognitive task, in accordance with some example embodiments. Referring to FIGS. 1A-C, 2A-B, and 4A, the process 400 may be performed to train a residual binary neural network such as, for example, the residual binary neural network 100.

At 402, the residual binary neural network 100 may be trained by at least processing, with the residual binary neural network 100, a training dataset during a first training epoch using a bounded, monotonically increasing function having a first slope to approximate one or more binary weights applied by the residual binary neural network 100. At 404, the residual binary neural network 100 may be trained by at least processing, with the residual binary neural network 100, the training dataset during a second training epoch using the bounded, monotonically increasing function having a second slope to approximate the one or more binary weights applied by the residual binary neural network 100. For example, training the residual binary neural network 100 may include updating one or more of the weights in the residual binary neural network 100 until the gradient of the error function associated with the residual binary neural network 100 converges, for example, to a local minimum and/or another threshold value. However, maximizing the slope α of the bounded, monotonically increasing function H(αW) at the start of training may also eliminate most of the gradient required to train the residual binary neural network 100.

Accordingly, in some example embodiments, the slope α of the bounded, monotonically increasing function H(αW) used to approximate the step function corresponding to the binary weights in the residual binary neural network 100 may be gradually increased during the training of the residual binary neural network 100. For example, the slope α of the bounded, monotonically increasing function H(αW) may be increased over successive training epochs in order to preserve the gradient of the error function associated with the residual binary neural network 100. As FIG. 3A shows, increasing the slope α of the bounded, monotonically increasing function H(αW) may increase its conformance to a step-function exhibiting an abrupt transition between two values to represent the binary weights applied in the residual binary neural network 100. By increasing the slope α gradually through the course of training the residual binary neural network, the resulting residual binary neural network 100 may include one or more semi-binarized weights.

At 406, in response to determining that the training of the residual binary neural network 100 is complete, replacing one or more semi-binarized weights included in the trained residual binary neural network 100 with one or more corresponding binary weights. For example, the training of the residual binary neural network 100 may be complete when the gradient of the error function associated with the residual binary neural network 100 converges, for example, to a local minimum and/or another threshold value. Upon determining that the training of the residual binary neural network 100 is complete, the semi-binarized weights that are included in the trained binary neural network 100 may be replaced with the corresponding binary weights.

At 408, the trained residual binary neural network 100 may be deployed to perform a cognitive task. The trained residual binary neural network 100 may be deployed as computer software and/or hardware (e.g., application specific integrated circuits (ASICs), field-programmable gate arrays (FPGAs), and/or the like). Moreover, the trained residual binary neural network 100 may be deployed in any manner including, for example, as part of a web service, a cloud-based service (e.g., a software-as-a-service (SaaS)), a mobile application, and/or the like. For example, the trained residual binary neural network 100 may be deployed to perform a classification task that requires the trained residual binary neural network 100 to assign input samples to one or more categories. Alternatively and/or additionally, the trained residual binary neural network 100 may be trained to perform a regression task that includes predicting, based at least on variations in one or more independent variables, corresponding changes in one or more dependent variables.

At 410, the trained residual binary neural network 100 may perform the cognitive tasks by at least applying, to an output generated by an activation function associated with one or more neurons in the trained residual binary neural network 100, a multi-level binarization scheme to generate an estimate of the output having a first bit providing a first binary representation of the output of the activation function and a second bit providing a second binary representation of a residual error associated with the first binary representation of the output of the activation function. As shown in FIG. 1C, the trained residual binary neural network 100 may include a plurality of neurons such as, for example, the neuron 150. The neuron 150 may be configured to apply, to one or more inputs (e.g., i₁, i₂, . . . iₙ), one or more corresponding weights from the weight vector \vec{w} (e.g., w₁, w₂, . . . wₙ). The neuron 150 may be further configured to apply the activation function Ø to the one or more weighted inputs (e.g., w₁i₁, w₂i₂, . . . wₙiₙ). Moreover, the output x of the activation function Ø may be binarized, for example, by applying a binarization function β.

In some example embodiments, the binarization function β may apply the multi-level binarization scheme 200. Referring to FIG. 2A, the multi-level binarization scheme 200 may generate the result e to include a sequence of l quantity of bits (e.g., b₁, b₂, . . . , bᵢ) in which the residual error associated with the value represented by one bit in the sequence of bits may be represented by one or more subsequent bits in the sequence of bits. For example, the result e may include the first bit b₁ corresponding to the first estimate e₁ of the output x, the second bit b₂ corresponding to the second estimate e₂ of the first residual error r₁ associated with the first estimate e₁, and the third bit b₃ corresponding to the third estimate e₃ of the second residual error r₂ associated with the second estimate e₂. The first residual error r₁ may correspond to a difference between the output x and the value (e.g., γ₁ or −γ₁) of the first estimate e₁. Alternatively and/or additionally, the second residual error r₂ may correspond to a difference between the first residual error r₁ and the value (e.g., γ₂ or −γ₂) of the second estimate e₂.

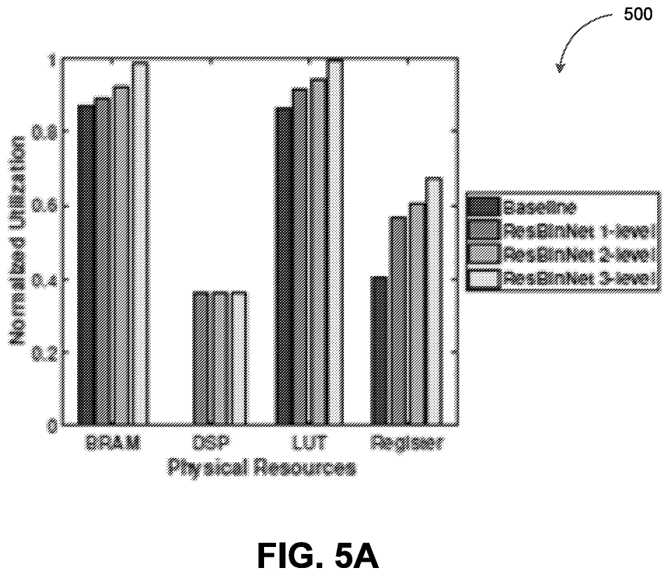

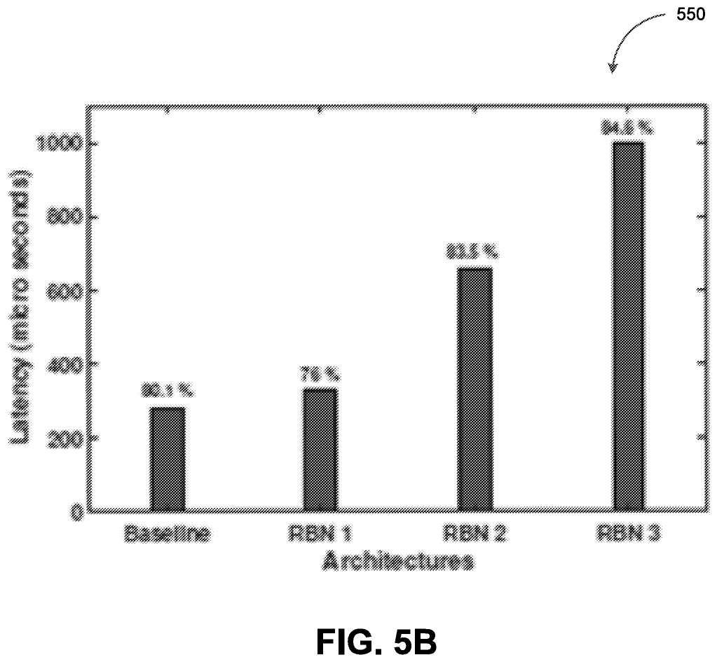

According to some example embodiments, the residual binary neural network 100 may consume fewer resources and be associated with less computational complexity than a conventional full-precision neural network. Moreover, the residual binary neural network 100 may be more accurate and susceptible to training than a conventional binary neural network. To further illustrate, FIG. 5A depicts a graph 500 illustrating the resource utilization associated with the residual binary neural network 100, in accordance with some example embodiments. Graph 500 depicts a comparison of the utilization of different field-programmable gate array (FPGA) resources such as, for example, block random access memory (BRAM), digital signal processors (DSP), lookup tables (LUT), registers, and/or the like. As graph 500 shows, increasing the level of binarization in the residual binary neural network 100 may trigger modest increases in resource utilization.

Meanwhile, FIG. 5B depicts a graph 550 illustrating a tradeoff in the latency and accuracy of the residual binary neural network 100, in accordance with some example embodiments. As noted, increasing the levels of binarization in the residual binary neural network 100 may increase the accuracy of the residual binary neural network 100, for example, in performing one or more cognitive tasks. Increasing the levels of binarization in the residual binary neural network 100 may trigger a modest increase in the latency associated with the residual binary neural network 100.

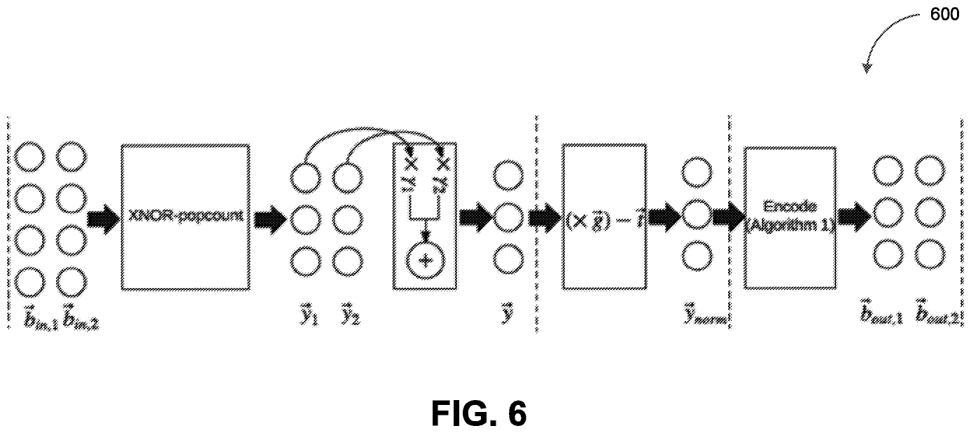

FIG. 6 depicts a schematic diagram illustrating an example of a hardware architecture 600 for implementing a residual binary neural network, in accordance with some example embodiments. For example, in some example embodiments, the residual binary neural network 100 may be implemented using the hardware architecture 600. At least a portion of the hardware architecture 600 may be a hardware accelerator including, for example, one or more field programmable gate arrays (FPGAs), application specific integrated circuits (ASICs), and/or the like. As used herein, a hardware accelerator may refer to computer hardware (e.g., FPGAs, ASICs, and/or the like) that has been specifically configured to implement the residual binary neural network 100. Accordingly, at least a portion of the residual binary neural network 100 may be implemented using a hardware accelerator.

The hardware architecture 600 may be configured to process l streams of binary vectors where l may correspond to the quantity of levels of binarization applied, for example, by the binarization function β to the output x of the activation function Ø. To accommodate the multi-level binarization scheme, the hardware architecture 600 may include one or more hardware blocks configured to perform an exclusive NOR operation and a pop-count operation sequentially on a stream of binary vectors \vec{b}_{in,i}. In some example embodiments, the quantity of hardware blocks for performing the exclusive NOR (XNOR) operation and the pop-count operation may be fixed. For example, a single hardware block may be used to perform the exclusive NOR operation and the pop-count operation by at least performing the exclusive NOR operation and the pop-count operation on each bit in the stream of binary vectors \vec{b}_{in,i}, in sequence. That is, the same hardware block may be reused to perform the exclusive NOR operation and the pop-count operation on multiple bits from the stream of binary vectors \vec{b}_{in,i}, thereby obviating the need for additional hardware to accommodate additional levels of binarization in the multi-level binarization scheme 200.

Alternatively, the quantity of hardware blocks for performing the exclusive NOR (XNOR) operation and the pop-count operation may be determined based on the level of binarization associated with the multi-level binarization scheme 200. As noted, increasing the level of binarization may increase the accuracy of the residual binary neural network 100. Meanwhile, when the hardware architecture 600 include multiple hardware blocks for performing the exclusive NOR (XNOR) operation and the pop-count operation, these operations may be performed, at least partially in parallel, on multiple bits from the stream of binary vectors \vec{b}_{in,i}. This increase in the quantity of hardware blocks may engender a decrease in computation time, which may increase as the levels of binarization associated with the multi-level binarization scheme 200 increases.

Referring again to FIG. 6, the result of the exclusive NOR operation and the pop-count operation may be one or more vectors \vec{y}ᵢ. Meanwhile, the output \vec{y} of the matrix-vector multiplication unit may be computed as \vec{y}=Σᵢγᵢ\vec{γ}ᵢ. It should be appreciated that the computation overhead of the summation operation may be negligible compared to the computation overhead imposed by the exclusive NOR operation and the pop-count operation.

As shown in FIG. 6, the hardware architecture 600 may be configured to perform batch-normalization during the inference phase by at least multiplying a vector \vec{y} by constant vector \vec{g} and subtracting a vector \vec{t} to obtain the normalized vector \vec{y}ₙₒᵣₘ. The multiplication operation may be necessitated by the effects of the normalized vector \vec{y}ₙₒᵣₘ, for example, on the output x of the activation function Ø of our activation function. The hardware architecture 600 may be further configured to encode the normalized vector \vec{y}ₙₒᵣₘ into a stream of binary vectors \vec{b}_{out,i}. A pooling function (e.g., max pooling and/or the like) applied, for example, by the pooling layers 130 of the residual binary neural network 100, may be performed directed on the encoded values in the stream of binary vectors \vec{b}_{out,i}.

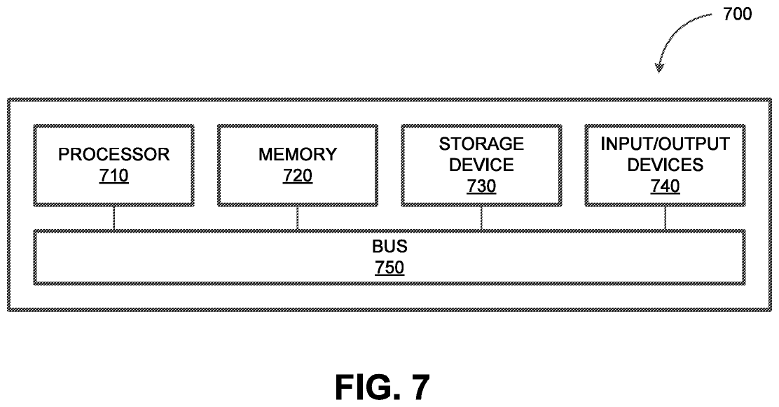

FIG. 7 depicts a block diagram illustrating a computing system 700, in accordance with some example embodiments. Referring to FIGS. 1 and 7, the computing system 700 can be used to implement the residual binary neural network 100 and/or any components therein.

As shown in FIG. 7, the computing system 700 can include a processor 710, a memory 720, a storage device 730, and input/output devices 740. The processor 710, the memory 720, the storage device 730, and the input/output devices 740 can be interconnected via a system bus 750. The processor 710 is capable of processing instructions for execution within the computing system 700. Such executed instructions can implement one or more components of, for example, the residual binary neural network 100. In some implementations of the current subject matter, the processor 710 can be a single-threaded processor. Alternately, the processor 710 can be a multi-threaded processor. The processor 710 is capable of processing instructions stored in the memory 720 and/or on the storage device 730 to display graphical information for a user interface provided via the input/output device 740.

The memory 720 is a computer readable medium such as volatile or non-volatile that stores information within the computing system 700. The memory 720 can store data structures representing configuration object databases, for example. The storage device 730 is capable of providing persistent storage for the computing system 700. The storage device 730 can be a floppy disk device, a hard disk device, an optical disk device, or a tape device, or other suitable persistent storage means. The input/output device 740 provides input/output operations for the computing system 700. In some implementations of the current subject matter, the input/output device 740 includes a keyboard and/or pointing device. In various implementations, the input/output device 740 includes a display unit for displaying graphical user interfaces.

According to some implementations of the current subject matter, the input/output device 740 can provide input/output operations for a network device. For example, the input/output device 740 can include Ethernet ports or other networking ports to communicate with one or more wired and/or wireless networks (e.g., a local area network (LAN), a wide area network (WAN), the Internet).

In some implementations of the current subject matter, the computing system 700 can be used to execute various interactive computer software applications that can be used for organization, analysis and/or storage of data in various (e.g., tabular) format (e.g., Microsoft Excel, and/or any other type of software). Alternatively, the computing system 700 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 740. The user interface can be generated and presented to a user by the computing system 700 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

1. A system, comprising:
at least one processor; and
at least one memory including program code which when executed by the at least one processor provides operations comprising:
training, based at least on a training dataset, a machine learning model, the machine learning model including a first neuron configured to generate an output by at least applying, to one or more inputs to the first neuron, an activation function, the output of the activation function being subject to a multi-level binarization function configured to generate an estimate of the output, and the estimate of the output including a first bit providing a first binary representation of the output and a second bit providing a second binary representation of a first residual error associated with the first binary representation of the output; and
in response to determining that the training of the machine learning model is complete, deploying the trained machine learning model to perform a cognitive task.

2. The system of claim 1, wherein the first neuron is further configured to apply, to the one or more inputs, at least one binary weight having one of two values prior to applying the activation function.

3. The system of claim 2, wherein the training of the machine learning model comprises:
processing, with the machine learning model, the training dataset during a first training epoch using a function having a first slope to approximate the at least one binary weight; and
processing, with the machine learning model, the training dataset during a second training epoch using the function having a second slope to approximate the at least one binary weight.

4. The system of claim 3, wherein the first training epoch and/or the second training epoch comprises a forward pass and a backward pass of the training dataset through the machine learning model.

5. (canceled)

6. (canceled)

7. The system of claim 3, wherein the second slope is greater than the first slope to increase a conformance between the function and a step function representative of the at least one binary weight.

8. The system of claim 3, wherein using the function to approximate the at least one binary weight during the training of the machine learning model generates the trained machine learning model to include one or more semi-binarized weights, and wherein the one or more semi-binarized weights are replaced with one or more corresponding binary weights prior to the deployment of the trained machine learning model to perform the cognitive task.

9. (canceled)

10. The system of claim 1, wherein the first residual error comprises a first difference between the output and a first value corresponding to the first binary representation of the output, and wherein the second residual error comprises a second difference between the first residual error and a second value corresponding to the second binary representation of the first residual error.

11. (canceled)

12. The system of claim 1, wherein the estimate of the output further includes a third bit providing a third binary representation of a second residual error associated with the second binary representation of the first residual error.

13. The system of claim 1, wherein the machine learning model further includes a second neuron configured to receive, as an input, the estimate of the output of the activation function applied at the first neuron, and wherein the second neuron is further configured to apply, to the estimate of the output of the activation function, one or more binary weights.

14. The system of claim 13, wherein the one or more binary weights are applied to the estimate of the output of the activation function by determining a dot product between the one or more binary weights and the estimate of the output of the activation function.

15. The system of claim 14, wherein the dot product is determined by performing an exclusive NOR (XNOR) operation between the one or more binary weights and the estimate of the output of the activation function, and wherein the dot product is further determined by performing a pop-count operation to determine a quantity of bits set by the exclusive NOR (XNOR) operation.

16. The system of claim 15, wherein a fixed quantity of hardware blocks are used to perform the exclusive NOR (XNOR) operation and the pop-count operation.

17. The system of claim 15, wherein a quantity of hardware blocks used to perform the exclusive NOR (XNOR) operation and the pop-count operation are determined based at least on a quantity of levels of binarization associated with the multi-level binarization function.

18. The system of claim 15, wherein a single hardware block is configured to perform the exclusive NOR (XNOR) operation and the pop-count operation on the first bit comprising the estimate of the output of the activation function and the second bit comprising the estimate of the output of the activation function sequentially.

19. The system of claim 15, wherein multiple hardware blocks are configured to perform the exclusive NOR (XNOR) operation and the pop-count operation on the first bit comprising the estimate of the output of the activation function and the second bit comprising the estimate of the output of the activation function at least partially in parallel.

20. (canceled)

21. The system of claim 1, wherein the machine learning model comprises a binary neural network.

22. (canceled)

23. The system of claim 1, wherein the activation function comprises a sigmoid function and/or a rectified linear unit (ReLU) function.

24. The system of claim 1, further comprising:
performing the cognitive task by at least applying the trained machine learning model; and
providing, as a result of the cognitive task, an output of the trained machine learning model.

25. (canceled)

26. A computer-implemented method, comprising:
training, based at least on a training dataset, a machine learning model, the machine learning model including a first neuron configured to generate an output by at least applying, to one or more inputs to the first neuron, an activation function, the output of the activation function being subject to a multi-level binarization function configured to generate an estimate of the output, and the estimate of the output including a first bit providing a first binary representation of the output and a second bit providing a second binary representation of a first residual error associated with the first binary representation of the output; and
in response to determining that the training of the machine learning model is complete, deploying the trained machine learning model to perform a cognitive task.

27-49. (canceled)

50. A non-transitory computer-readable medium storing instructions, which when executed by at least one data processor, result in operations comprising:
training, based at least on a training dataset, a machine learning model, the machine learning model including a first neuron configured to generate an output by at least applying, to one or more inputs to the first neuron, an activation function, the output of the activation function being subject to a multi-level binarization function configured to generate an estimate of the output, and the estimate of the output including a first bit providing a first binary representation of the output and a second bit providing a second binary representation of a first residual error associated with the first binary representation of the output; and
in response to determining that the training of the machine learning model is complete, deploying the trained machine learning model to perform a cognitive task.

51-103. (canceled)
